(19) United States
(12) Patent Application Publication
(10) Pub. No.: US 2008/0256530 A1
(43) Pub. Date: Oct. 16, 2008

(54) System and Method for Determining Firmware Compatibility for Migrating Logical Partitions

(76) Inventors: William Joseph Armstrong, Rochester, MN (US); Robert J. Battista, Rochester, MN (US); David Anthony Larson, Rochester, MN (US); Naresh Nayar, Rochester, MN (US); Jonathan Ross Van Niewaal, Rochester, MN (US)

Correspondence Address: WOOD, HERRON & EVANS, L.L.P. (IBM), 2700 CAREW TOWER, 441 VINE STREET, CINCINNATI, OH, 45202, US

(21) Appl. No.: 11/735,770

(22) Filed: Apr. 16, 2007

(51) Int. Cl. G06F 9/445

(52) U.S. Cl. 717/174

(57) ABSTRACT

An apparatus, program product and method for facilitating logical partition migrations between computers by determining if the firmware of the computers is compatible. A hypervisor of a source logical partition may transfer a token and compatibility table indicative of firmware running on the source computer. A hypervisor on the system of the target logical partition may compare the firmware indicated by the token with a token and/or compatibility table listing firmware versions compatible with the target computer. Conversely, a token of the target computer may be compared to a compatibility table associated with firmware that is compatible with the source computer. In either instance, a match may result in the migration of the logical partition. Alternatively, an absence of a match may result in the migration being prohibited.

### CROSS-REFERENCE TO RELATED APPLICATIONS

This application is related to the following U.S. Patent Applications all filed on even date herewith, the disclosures of which are incorporated by reference herein: No. ______, entitled “SYSTEM AND METHOD FOR TRACKING THE MEMORY STATE OF A MIGRATING LOGICAL PARTITION” by William Joseph Armstrong et al. (ROC920070008US1); No. ______, entitled “SYSTEM AND METHOD FOR MAINTAINING PAGE TABLES USED DURING A LOGICAL PARTITION MIGRATION” by Stuart Zachary Jacobs et al. (ROC920070009US1); and No. ______, entitled “SYSTEM AND METHOD FOR UPDATING A TIME-RELATED STATE OF A MIGRATING LOGICAL PARTITION” by William Joseph Armstrong et al. (ROC920070015US1).

### FIELD OF THE INVENTION

The present invention relates to computing systems, and more particularly, to managing a logical partition migration between computer systems.

### BACKGROUND OF THE INVENTION

Data migration refers generally to the processes of moving computer data from one computer location to another. For instance, an administrator may facilitate maintenance or updates by transferring applications and/or memory from one operating system or computer to another. While necessary, data migration can pose a tremendous challenge and risk to businesses, government agencies and individuals that depend upon uninterrupted computer access. Too often, software installation problems occur. Such problems may be attributable to faulty program code or unforeseeable interactions within a processing environment. For example, a migrated application may be incompatible with hardware or firmware at the new location. Such problems can result in costly system errors and downtime.

Problems stemming from incompatibility may be compounded in logically partitioned environments, where unique resource sharing and access practices may present additional considerations. Logical partitioning provides a programmed architecture suited for assigning and sharing computing assets. A partition may logically comprise a portion of a machine's physical processors, memory and other resources. As such, an administrator may allocate the same resources to more than one partition. Each partition may additionally host an operating system, in addition to multiple virtual processors. An underlying program called a hypervisor, or partition manager, assigns and dispatches physical processors to each virtual processor. Each partition typically has unique connections for communicating with a network. In this manner, each partition operates largely as if it is a separate computer.

During a migration, the state of the migrating logical partition, including applicable memory, processor/register state information, and connection information regarding physical interface/discs associated with the virtual partition components, etc., is transferred to another logical partition of another computer. The migration may be motivated to accommodate new hardware or program updates on the computer of the migrating logical partition. Oftentimes the migrated logical partition is eventually returned to the original logical partition location.

The migrating partition ideally continues work without interruption on the new logical partition. To this end, the migrating partition may run in a virtualized environment during the migration to be separate from the physical hardware underneath. The hypervisor may be responsible for providing the infrastructure that allows for the migration to occur from the source logical partition to a target logical partition. The target logical partition may be newly created for the migration, is typically located on a separate, physical computer, and is configured to accommodate the state of the transferred logical partition.

In scenarios where a logical partition is migrating to another server computer, it is possible that the transferring, or source computer, has different firmware attributes than the receiving, or target computer. Firmware generally includes coded instructions that are stored permanently in read-only memory. Embodiments of firmware may comprise system firmware, i.e., a layer of firmware that may run on the same processors as the operating system and may be used to provide a low level of interface to various hardware components, while isolating the operating system from the details of that hardware access.

In one scenario, the target and source server computer may have different firmware release versions, fix levels, and/or interface compatibilities. As a result, the source and target logical partitions may be unable to communicate and accomplish a successful migration. More particularly, incompatible firmware could lead to a partition outage or a lack of data integrity in the migrating partition. Any such problem stemming from an unsuccessful migration can thus result in the loss of business and man hours. Even where an administrator is skilled enough to manually and preemptively verify that the compatibility of a migrating logical partition pair, the manual process can be preclusively tedious and complicated. Such potential problems may further translate into a reluctance to migrate partitions in instances where such transfers would otherwise improve system performance.

There is consequently a need for an improved manner of migrating data and associated processes within a logically partitioned environment.

### SUMMARY OF THE INVENTION

The present invention provides an apparatus, method and program product that addresses these and other problems of the prior art by providing, in part, a mechanism for automatically determining if two computers are running firmware that can communicate and successfully migrate a logical partition between the two computers. In one aspect of the invention, processes manage a migration of a source logical partition to a target logical partition by automatically determining if firmware used by the source logical partition is compatible with firmware used by the target logical partition. If so, then the migration of the source logical partition may be allowed to proceed. Alternatively, a determination of firmware incompatibility may prevent the migration from occurring.

To this end, an embodiment consistent with the invention may compare a source token indicative of the firmware used by the source logical partition with a target token indicative of the firmware used by the target logical partition. In another aspect of the invention, a source token indicative of the firmware used by the source logical partition may be compared with a target compatibility table indicative of firmware compatible with the firmware used by the target logical partition. Conversely, embodiments consistent with the invention may compare a target token indicative of the firmware used by the target logical partition with a source compatibility table indicative of firmware compatible with the firmware used by the source logical partition.

Where desired, the source and/or target compatibility tables may be updated to reflect newer firmware versions and/or levels. Compatibility determinations may involve evaluating at least one of a version and a level of the firmware. Compatibility tables may indicate that older firmware is compatible with updated firmware for determination considerations.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a block diagram of a computer system configured to accomplish a data migration operation in accordance with the principles of the present invention.

FIG. 2 is a block diagram of select software components and resources consistent with the computer of FIG. 1.

FIG. 3 is a flowchart having steps executable by the system of FIG. 1 for conducting a migration of the local partition of FIG. 1.

FIG. 4 is a flowchart having steps executable by the system of FIG. 1 for determining compatibility or incompatibility of firmware as between computer systems attempting a migration of a logical partition.

### DETAILED DESCRIPTION

Features of the present invention include an apparatus, program product and method for facilitating logical partition migrations between computers by determining if the firmware of the computers is compatible. A hypervisor of a source logical partition may transfer a token indicative of firmware running on the source computer. The hypervisor associated with the target logical partition may compare the firmware indicated by the token with a token and/or compatibility table listing firmware versions compatible with the target computer. Conversely, a token of the target computer may be compared to a compatibility table associated with firmware that is compatible with the source computer. In either instance, a match may result in the migration of the logical partition. Alternatively, an absence of a match may result in the migration being prohibited.

When migrating, a logical partition may run in a virtualized environment to be separate from the physical hardware underneath. The hypervisor may be responsible for providing the infrastructure that allows for the migration to occur from the source logical partition to a typically new, target logical partition. The target logical partition may be newly created for the migration, having “skeletal” characteristics so as to accommodate the transferred logical partition. After a migration is complete, some layers of the firmware may be upgraded concurrently on the target system. Aspects of the invention may block a migration if the source computer layer of firmware cannot be upgraded concurrently with the target firmware release, otherwise the layer of firmware cannot be maintained on the target computer without a partition reboot.

In this manner, embodiments may ensure that firmware releases, e.g., levels and fixes, between the source and target computers are checked for compatibility. A level generally comprises a version of firmware, and a fix may comprise a programmatic upgrade, or a patch, to the level.

Put another way, embodiments may compare firmware indicated by tokens to compatibility tables indicative of compatible firmware data. Embodiments may check the firmware compatibility in both directions (i.e., from the source to the target, as well as from the target to the source) to ensure that the migrated partition can be successfully moved back to the original/transferring computer at a later time. This bidirectional firmware compatibility may ensure that the unique level of each version of the firmware is taken into account. Respective compatibilities of embodiments may allow a migration between an older level and a newer level of firmware without the older firmware requiring a patch.

Aspects of the invention may validate the compatibility of the communication interfaces between the respective hypervisors of the migrating partition pair. Communication between the partition involved in the migration may be enabled such that either partition of the migration pair can decode information that is relevant for the logical partition interpreting the data. The mechanism for this process may utilize tokens that are sent between the partitions and associated computer systems.

Data sent between the partitions may include a basic header that is common and has a known location for the tokens. When the data is generated by one of the computers, a token may be placed in it to represent the version that was used to create it. The data also may contain tokens specifying the minimum compatibility version that is required to interpret it. The created version may allow a newer firmware level to determine whether it supports the data and how to interpret it. Reading the minimum compatibility level may allow older firmware to determine if the data is valid for that level. By formatting the data so that fields may be interpreted by all supported levels, this process of versioning may allow data to be sent between two partitions and associated computers that are at different firmware levels.

In some embodiments, the communicated data may have two version entries that allow the data layout/firmware to be identified. For example, the oldest compatible version may signify the level that the computer supporting the migrating partition includes a format similar to what is being used on the target partition. As long as fields are added and not moved, the oldest compatible version would not have to change. The oldest level may only need to be changed if the data format could no longer be processed using the older layouts. The version field may allow the firmware processing the data to determine what template it should use to determine the data format. If the data is processed by firmware that is older than the version of the data, but at least the same level as the oldest, then processing may proceed. This initial determination may ensure that the firmware on the source computer, i.e, the computer from which the logical partition migrates, and the target computer, i.e., the computer to which the logical partition migrates, can communicate with each other.

In another aspect of the invention, embodiments may check that firmware levels are compatible by making use of two tables (a source compatibility table and the target compatibility table) that have tokens representing versions and levels of firmware compatible with for migration. The source table, for instance, may indicate the set of target firmware releases and levels with which the source computer is aware and compatible. Conversely, the target table may indicate a set of source firmware releases and levels that the computer knows about and is compatible with.

In one embodiment, an entry in the source table may represent the oldest (minimum) level of the target computer firmware (for the release represented by the row) with which the source computer is compatible. An entry in the target table may represent the oldest (minimum) level of the source computer firmware (for the release represented by the row) with which the target computer is compatible. Where so configured, a special value of all “1's” for the table entry level may indicate that the corresponding firmware release may not be compatible with release of the partition and associated computer. As such, table entries of embodiments may indicate incompatible versions.

The hypervisor associated with the source logical partition in one embodiment may send its source compatibility table to the hypervisor associated with the target logical partition, along with a token that represents its current level of firmware. The current level of the source firmware may be interrogated to determine if the firmware levels are compatible. The hypervisor of the target logical partition may check the current firmware token supplied by the source logical partition against its target firmware compatibility table. If a match is not found, the source table sent by the source computer may then be interrogated to determine if there is a match with the current firmware token of the target logical partition indicating that the two firmware levels are compatible. If no match is found using the above algorithm, the migration may not be allowed to proceed.

Since the level of firmware within a version may change depending on the amount and number of fixes applied to the firmware, the compatibility table may also be updated whenever a new service pack is applied to the system. This dynamic capability to update the firmware table may provide flexibility. For example, a server computer may be running on version 2, level 40, and a target computer may be running on version 3, level 80. When a version is released, there may be no way to predict what later versions and levels might be compatible with the released version. Continuing with the above example, the source table provided on the target system may have an entry in the firmware table indicating that the source firmware is compatible with version 2, level 20. This may indicate that the source firmware is compatible with a version 2 firmware that is at least level 20 or later.

In an instance where the current version 2 level of firmware was not compatible when version 3 was made available, there may be no entry in the target firmware table to indicate compatibility with any version 2 levels. However, version 2 may subsequently create a new level that is now compatible with version 3. Applying and activating a new version 2 may include installing a new firmware table that contains entries that now indicate that the version (with the updated level) is compatible with version 3.

Embodiments may thus provide an automated way of determining firmware compatibility between multiple firmware versions and levels of firmware. If two releases of firmware have not been tested together (even though they may be compatible), either there may be no entry in the two sets of tables that indicate a match, or there may be any entry with a value of all “1's.” Either way, the migration may not be allowed to proceed.

Similarly, for a level of firmware that requires that the level be concurrently updated to the level of the target computer, the above approach may be used to automatically block the migration if a concurrent update of that layer of the firmware from the source level to the target level is not supported.

### Hardware and Software Environment

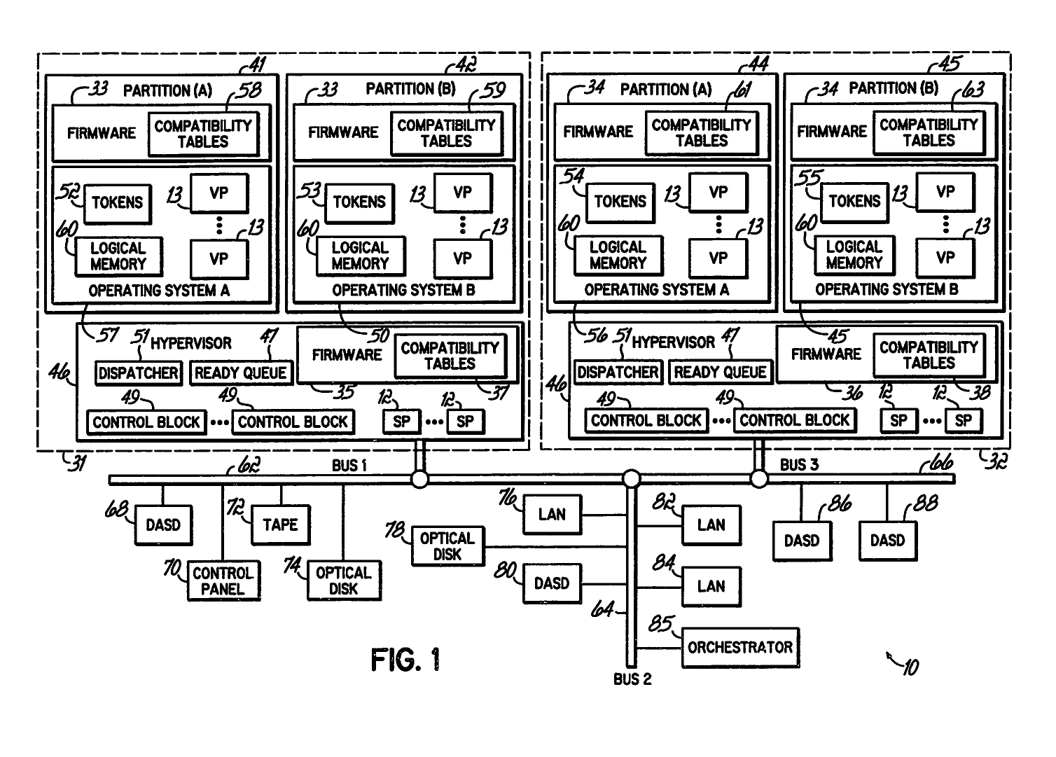

Turning more particularly to the drawings, FIG. 1 illustrates a data processing system 10, or apparatus, configured to accomplish a data migration operation in accordance with the principles of the present invention. System 10 more particularly represents the primary software components and resources used to implement a logically partitioned environment consistent with embodiments of the invention. As such, FIG. 1 includes a computing architecture characterized as a virtual machine design, as developed by International Business Machines Corporation. The networked system 10 includes a plurality of partitions 41, 42 and 44, 45 that may share common processing resources among multiple processes within their respective server computers 31, 32. Each computer 31, 32 may rely upon a single computing machine having one or more physical processors 12, or central processing units (CPU's). The physical processors 12 may execute software configured to simulate multiple virtual processors 13.

The partitions 41, 42, 44, 45 may logically comprise a portion of a system's physical processors 12, memory and other resources as assigned by an administrator. Each partition 41, 42, 44, 45 typically hosts an operating system 48, 50, 56, 57 and may have multiple virtual processors 13. In this manner, each partition 41, 42, 44, 45 may operate largely as if it is a separate computer.

As shown in FIG. 1, the environment comprising each partition 41, 42, 44, 45 may also include tokens 52, 53, 54, 55 and compatibility tables 58, 59, 61, 63. Tokens 52, 53, 54, 55 may include data indicative of a firmware version and/or level that is currently executing on the computer 31 hosting the partition 41 associated with the token 52. As discussed herein, the token 52 may be used in a comparison to determine whether the respective firmware 33, 34 of the computers 31, 32 is compatible. Compatibility tables 58, 59, 61, 63 typically comprise a listing or other information indicative of firmware versions and/or levels with which the target computer may be compatible. In one embodiment, identifying data from the source token 53 may be compared to firmware data of the compatibility table 61 of the target computer 32.

Underlying programs, called hypervisors 46, or partition managers, may use this scheme to assign physical resources to each partition 41, 42, 44, 45. For instance, a hypervisor 46 may intercept requests for resources from operating systems 48, 50, 56, 57 to globally share and allocate resources. If the partitions 41, 42 and 44, 45 within each server 31, 32 are respectively sharing processors 12, the hypervisor 46 allocates physical processor cycles between the virtual processors 13 of the partitions 41 and 42, 44 and 45 sharing the physical processors 12. Hypervisors 46 may include their own firmware 35, 36 and appropriate compatibility tables 37, 38 as with the partitions 41, 42, 44, 45. Moreover, for purposes of this specification, the partitions may use either or both the firmware of the partition and hypervisor.

Each operating system 48, 50, 56, 57 controls the primary operations of its respective logical partition 41, 42, 44, 45 in a manner similar to the operating system of a non-partitioned computer. Each logical partition 41, 42, 44, 45 may execute in a separate memory space, represented by logical memory 60. Moreover, each logical partition 41, 42, 44, 45 may be statically and/or dynamically allocated a portion of the available resources in its respective computer 31, 32 of networked system 10. For example and as discussed herein, each logical partition 41, 42, 44, 45 may share one or more physical processors 12, as well as a portion of the available memory space for use in logical memory 60. In this manner, a given processor may be utilized by more than one logical partition.

The hypervisors 46 may include a dispatcher 51 that manages the dispatching of virtual processors to physical processors on a dispatch list, or ready queue 47. The ready queue 47 comprises memory that includes a list of virtual processors having work that is waiting to be dispatched on a physical processor 12. The hypervisors 46 shown in FIG. 1 also includes physical processors 12, in addition to processor control blocks 49. The processor control blocks 49 comprise memory that includes a list of virtual processors waiting for access on a particular physical processor 12.

Additional resources, e.g., mass storage, backup storage, user input, network connections, and the like, are typically allocated to one or more logical partitions in a manner well known in the art. Resources can be allocated in a number of manners, e.g., on a bus-by-bus basis, or on a resource-by-resource basis, with multiple logical partitions sharing resources on the same bus. Some resources may even be allocated to multiple logical partitions at a time. FIG. 1 illustrates, for example, three logical buses 62, 64 and 66, with a plurality of resources on bus 62, including a direct access storage device (DASD) 68, a control panel 70, a tape drive 72 and an optical disk drive 74, allocated to a partition. Bus 64, on the other hand, may have resources allocated on a resource-by-resource basis, e.g., with local area network (LAN) adaptor 76, optical disk drive 78 and DASD 80 allocated to logical partition 42, and LAN adaptors 82 and 84 allocated to logical partition 44. Bus 66 may represent, for example, a bus allocated specifically to logical partition 44, such that all resources on the bus, e.g., DASD's 86 and 88, are allocated to the same logical partition.

An orchestrator program 85 may communicate with migrating partitions to coordinate and otherwise facilitate the migration, as described below in detail. While the orchestrator program 85 program is shown in FIG. 1 as being networked to the pair of servers 31 and 32 of system 30, one skilled in the art should appreciate that another orchestrator program may be located within a server computer 31, 32 or other location within the system 30 suitable to manage the migration between a pair of migrating partitions.

It will be appreciated that the illustration of specific resources in FIG. 1 is merely exemplary in nature, and that any combination and arrangement of resources may be allocated to any logical partition in the alternative. For instance, it will be appreciated by one of skill in the art that in some implementations resources can be reallocated on a dynamic basis to service the needs of other logical partitions. Furthermore, it will be appreciated that resources may also be represented in terms of the input/output processors (IOP's) used to interface the computer with the specific hardware devices.

The various software components and resources illustrated in FIG. 1 may be implemented in a number of manners, including using various computer software applications, routines, components, programs, objects, modules, data structures, etc., referred to hereinafter as “computer programs”, “tools”, “programs” or “program code”. Program code typically comprises one or more instructions that are resident at various times in various memory and storage devices in the computer, and that, when read and executed by one or more processors in the computer, cause that computer to perform the steps necessary to execute steps or elements embodying the various aspects of the invention.

Moreover, while the invention has and hereinafter will be described in the context of fully functioning computers, those skilled in the art will appreciate that the various embodiments of the invention are capable of being distributed as a program product in a variety of forms, and that the invention applies equally regardless of the particular type of computer readable medium used to actually carry out the distribution. Examples of computer readable media include, but are not limited to tangible, recordable type media such as volatile and non-volatile memory devices, floppy and other removable disks, hard disk drives, magnetic tape, optical disks (e.g., CD-ROM's, DVD's, etc.), among others, and transmission type media such as digital and analog communication links.

In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Those skilled in the art will recognize that the exemplary environment illustrated in FIG. 1 is not intended to limit the present invention. Though not shown in FIG. 1, for instance, one skilled in the art will appreciate that other partitions may be included within other embodiments, including a partition that comprises part of the hypervisors 46. This hypervisor partition may function in many ways like the conventional partitions 41, 42, 44, 45 (and associated operating systems), but has no user interface for the customer to protect it from failures that might otherwise come about through user interaction. Furthermore, while four logical partitions 41, 42, 44, 45 are shown in FIG. 1, one skilled in the art will appreciate that more or fewer partitions may be implemented as needed. Other alternative hardware and/or software environments may thus be used without departing from the scope of the invention.

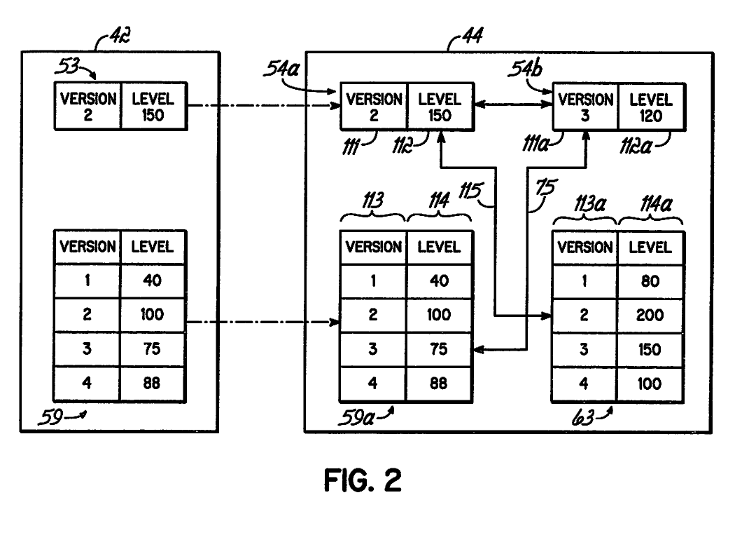

FIG. 2 is a block diagram showing in greater detail the token and compatibility table components and interactions of FIG. 1. More particularly, FIG. 2 shows a migration of source logical partition 42 to target logical partition 44. As part of the firmware compatibility determination, copies of a token 53 and a compatibility table 59 of the source logical partition 42 may be transferred to the target logical partition 44. As discussed herein, the copy of the source token 54a may be initially compared to the token 54b of the target logical partition 44.

As shown in FIG. 2, the copy of the source target token 54a includes data 111, 112 indicative of version 2, level 150 firmware. The target token 54b includes corresponding data 111a, 112a indicative of firmware 34 that comprises version 3 and level 120. As the respective versions and levels of the tokens 54a and 55b are not identical, the system 10 may next evaluate the copy of the source token 54a against the target compatibility table 63. More specifically, the target logical partition 44 may determine if the compatibility table 63a includes an identical version of firmware, as indicated by the copy of the source token 54a.

Since the version 111 of the source token 54a matches one of the compatible versions 113a of the target compatibility table 63, the system 10 may next determine if the level of the copy of the source token 54a is higher, or more recent, than that of the level 114a associated with the appropriate version 113a of the target compatibility table 63.

As shown in the exemplary embodiment of FIG. 2, the above compatibility criterion is not satisfied. Because the level of the source token 54a is older (and lower, i.e., “150” vs. “200”), the result of this portion of the firmware determination process is negative.

The target logical partition 44 may then compare the version 111a and level 112a of the target token 54b to the versions 113 and levels 114 of the copy of the source partition's compatibility table 59a. Namely, the version 111a of the target token 54b may be compared to the versions 113 of the copy of the compatibility table 59a of the source 42. As shown in the embodiment of FIG. 2, matching versions (i.e, “3”)are present in both the token 54b and table 59a.

The respective firmware levels 112a and 114 may also be compared to further determine firmware compatibility. Because the level 112a of the target token is compatible with the older level indicated by the copy of the compatibility table 59a, the firmware 33, 34 may be determined as being compatible. As such, the migration of the source logical partition 42 to the target logical partition 44 may be allowed to proceed.

### Processes for Determining Firmware Compatibility for Logical Partition Migration

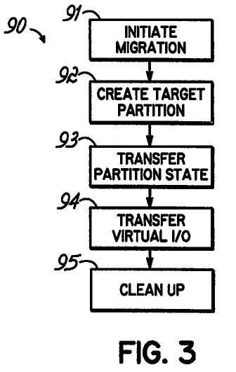

FIG. 3 is a flowchart 90 having steps executable by the system of FIG. 1 for executing a migration of the logical partition 42 of FIG. 1. Generally during a migration, the state of the migrating logical partition 42 is transferred to a newly created logical partition 44. The migrating partition 42 ideally continues work without interruption on the new logical partition 44 and on the target system 32.

Turning more particularly to the flowchart 90, migration processes may be initiated at block 91. Initiation processes may include prompting the orchestrator program 85 to initially communicate with a pair of logical partitions 42, 44 involved in an impending migration. The orchestrator program 85 may thus begin coordinating and otherwise facilitating the migration.

As such, the orchestrator program 85 may initiate the creation of the target partition 44 at block 92 of FIG. 3. As discussed herein, the target partition 44 is typically located on a separate, physical computer 32, and may comprise a relatively empty framework for accommodating the state of the transferred logical partition 42. Where so configured, the target logical partition 44 may include data used by the system 10 to ensure basic firmware compatibility between the target and source logical partitions 42, 44.

Memory and other state information, e.g. processor, clock and register state information, may be transferred at block 93 from the source logical partition 42 to the target logical partition 44. System processes may continue to track changes to the state information that may occur during the migration of the memory.

Similarly, virtual I/O data may be transferred at block 94 from the source logical partition 42 to the target logical partition 44. Examples of virtual I/O may include connections from the virtual components of the migrating partition to interfaces and physical resources, e.g., discs, on the source system 31. Such connection information may be transferred at block 94 so that the migrated logical partition may near seamlessly continue its work.

While the migrated logical partition was active on the source computer 31, the partition 42 may have utilized memory and other resources reserved for the partition 42 on the source system 31. Once the partition has migrated, however, it no longer needs those resources. At block 95 of FIG. 3, the orchestrator program 85 may free up the resources for other applications on the source computer 31.

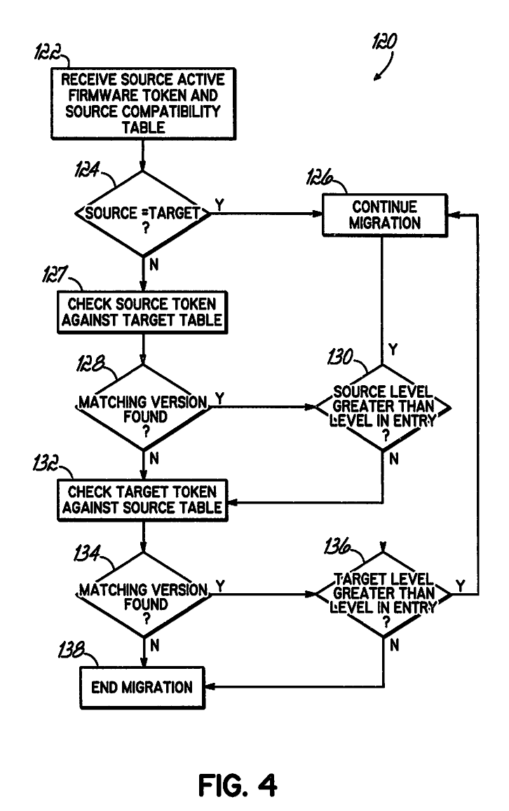

FIG. 4 is a flowchart 120 having steps executable by the system 10 of FIG. 1 for determining the compatibility or incompatibility of firmware 33, 34 as between computers 31, 32 attempting a migration of a logical partition 42. As such, the processes of the flowchart 100 may have application in the compatibility processes of FIG. 3. The steps of the flowchart 120 are taken from the perspective of the target logical partition 44. More particularly, the steps may be taken by the hypervisor 46 associated with the target logical partition. Turning more particularly to the flowchart 120, the hypervisor 46 of the source logical partition 42 may concurrently communicate at block 122 the source token 53 and compatibility table 59 to the target partition 44. The hypervisor 46 of the target partition 44 may determine at block 124 if the versions 111, 111a and/or levels 112, 112a of the source and target tokens 54a, 54b are the same. Such an identical match would indicate that the partitions are running the same firmware 33, 34. As a consequence, the migration would be allowed to continue at block 126.

Should the source and target tokens 54a, 54b alternatively not match at block 124, then the hypervisor 46 of the target partition 44 may check at block 127 the version 111 and level 112 of the source token 54a against the versions 113a and levels 114a of the compatibility table 63 of the target logical partition 44. Should a matching version be found at block 128, then the hypervisor 46 of the logical partition 44 may further determine whether the level 112 of the source token 54a is greater than the level 114a indicated in the target compatibility table 63. If so, then the firmware 33, 34 is determined to be compatible and the migration may continue at block 126.

Alternatively, should either no matching version be found at block 128, or the source level be lower at block 130, then the hypervisor 46 of the target logical partition 44 may initiate a comparison of the target token 54b against the copy of the source compatibility table 59a. Similar to the processes discussed above, the hypervisor 46 of the target logical partition 44 may determine if matching versions 111a, 113 exist as between the token 54b and compatibility table 59a. If so, then embodiments may additionally check the respective levels 112a, 114 of the token 54b and compatibility table 59a to determine if the levels are additionally compatible. If so, then the firmware 33, 34 of the partitions is compatible and the migration may continue at block 126.

Alternatively, should the comparison reveal that either the versions 111, 113 or the levels 112a, 114 of the target token 54b and compatibility table 59a are incompatible, then the migration process may be prohibited at block 138.

While the present invention has been illustrated by a description of various embodiments and while these embodiments have been described in considerable detail, it is not the intention of the applicants to restrict, or in any way limit, the scope of the appended claims to such detail. For instance, another embodiment supports migration between logical partitions between computer systems of the same physical machine. As such, a computer system for purposes of such an embodiment may include a portion of a hardware machine. As such, additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of Applicants' general inventive concept.

What is claimed is:

1. A method of managing a migration of a source logical partition to a target logical partition, the method comprising:
automatically determining if firmware used by the source logical partition is compatible with firmware used by the target logical partition; and
if so, allowing the migration of the source logical partition to proceed.

2. The method of claim 1, further comprising preventing the migration if the firmware is determined to be incompatible.

3. The method of claim 1, wherein automatically determining if the firmware is compatible further comprises comparing a source token indicative of the firmware used by the source logical partition with a target token indicative of the firmware used by the target logical partition.

4. The method of claim 1, wherein automatically determining if the firmware is compatible further comprises comparing a source token indicative of the firmware used by the source logical partition with a target compatibility table indicative of firmware compatible with the firmware used by the target logical partition.

5. The method of claim 1, wherein automatically determining if the firmware is compatible further comprises comparing a target token indicative of the firmware used by the target logical partition with a source compatibility table indicative of firmware compatible with the firmware used by the source logical partition.

6. The method of claim 1, further comprising updating a source compatibility table indicative of firmware compatible with the firmware used by the source logical partition.

7. The method of claim 1, further comprising updating a target compatibility table indicative of firmware compatible with the firmware used by the target logical partition.

8. The method of claim 1, wherein automatically determining if the firmware is compatible further comprises evaluating at least one of a version and a level of the firmware.

9. The method of claim 1, further comprising generating a token indicative of the firmware used by at least one of the source and target logical partitions.

10. The method of claim 1, wherein automatically determining if the firmware is compatible further comprises determining that older firmware is compatible with newer firmware.

11. An apparatus comprising:
a processor;
a target logical partition configured to use cycles of the processor; and
program code executable by the processor and in communication with the target logical partition, the program code configured to determine if firmware used by the target logical partition is compatible with firmware used by a source logical partition, and if so, to allow a migration of the source logical partition to the target logical partition.

12. The apparatus of claim 11, wherein the program code initiates preventing the migration if the firmware is determined to be incompatible.

13. The apparatus of claim 11, wherein the program code initiates comparing a source token indicative of the firmware used by the source logical partition with a target token indicative of the firmware used by the target logical partition.

14. The apparatus of claim 11, wherein the program code initiates comparing a source token indicative of the firmware used by the source logical partition with a target compatibility table indicative of firmware compatible with the firmware used by the target logical partition.

15. The apparatus of claim 11, wherein the program code initiates comparing a target token indicative of the firmware used by the target logical partition with a source compatibility table indicative of firmware compatible with the firmware used by the source logical partition.

16. The apparatus of claim 11, wherein the program code initiates updating a source compatibility table indicative of firmware compatible with the firmware used by the source logical partition.

17. The apparatus of claim 11, wherein the program code initiates updating a target compatibility table indicative of firmware compatible with the firmware used by the target logical partition.

18. The apparatus of claim 11, wherein the program code initiates evaluating at least one of a version and a level of the firmware.

19. The apparatus of claim 11, wherein the program code initiates determining that older firmware is compatible with newer firmware.

20. A program product, comprising:
program code in communication with source and target logical partitions, the program code configured to determine if firmware used by the source and target logical partitions is compatible, and if so, to allow a migration of the source logical partition to the target logical partition; and
a computer readable medium bearing the program code.
